(19) United States
(12) Patent Application Publication
(10) Pub. No.: US 2009/0111951 A1
(43) Pub. Date: Apr. 30, 2009

(54) BLEND AND PACKAGING MATERIAL UTILIZING THE SAME

(75) Inventors: Chih-hsiang Lin, Taipei (TW); Ya-Lan Chuang, Tainan County (TW); Pei-Jung Tsat, Taichung County (TW); Shu-Ling Yeh, Taoyuan County (TW); Chin-Lang Wu, Miaoli County (TW); Cing-Jiuh Kang, Hsinchu (TW); Hsin-Ching Kao, Hsinchu County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 12/049,435

(22) Filed: Mar. 17, 2008

(30) Foreign Application Priority Data
Oct. 29, 2007 (TW) 96140576

(51) Int. Cl. C08L 67/02

(52) U.S. Cl. 525/439

(57) ABSTRACT

The disclosed is a blend including 20 to 80 parts by weight of polycarbonate, 20 to 80 parts by weight of polyarylate, and 20 to 80 parts by weight of copolymer having a formula as below:

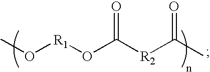

wherein R₁ is a combination of at least two of ethylene, cyclohexlene dimethylene, 2-methyl propyl, and neopentyl. R₂ is a combination of at least two of naphthalene, phenylene, butyl, and hexyl. n is a number of 1500 to 3000. The blend has high transparency, high thermal resistance, and high yellowing resistance under UV/climate, such that the blend is suitable to be applied in packaging material for light emitting device.

### BACKGROUND OF THE INVENTION

1. Field of the Invention

The invention relates to a blend, and in particular to a blend and packaging material utilizing the same.

2. Description of the Related Art

For light-emitting devices, packaging material is fairly important. For example, the packaging material used in light-emitting diodes (hereinafter LED) should have several properties such as transparency, thermal resistance, crystallinity, and impact resistance. Polyester is widely used as packaging material, but still possesses some shortcomings. For example, polycarbonate (hereinafter PC) and polyarylate (hereinafter PAR) have good transparency and thermal resistance (Tg>100° C.), however, yellowing resistance under UV and flow ability is unfavorable. On the other hand, poly ethylene terephthalate (hereinafter PET) has better yellowing resistance under UV and flow ability, but its T_{g} is only about 70° C., such that the PET does not meet the high thermal resistance (Tg>100° C.) for LED packaging material requirement. Some related arts replace the monomer terephthalic acid, so-called 1,4-benzenedicarboxylic acid, with 2,6-naphthalenedicarboxylic acid to form poly(ethylene 2,6-naphthalate) (hereinafter PEN) to solve the described problem. The PEN has higher crystallinity than PET and the T_{g} of PEN achieves 108° C., thereby effectively enhancing the thermal resistance of the packaging material. The PEN forms crystalline easily due to its high crystallinity, therefore reducing transparency and is unfavorable to forming a molten state for substantial injection packaging. For combining the easy processing of PET and the thermal resistance of PEN, some related arts blend these polymers. Because the standard of the blend is not unified and the blend properties is easily influenced by polymerizing degree or molar ratio of PET and/or PEN, the real application of the blend will confront difficulties such as reproduction and magnification. For combining the advantages of PET and PEN and standardizing the packaging material properties, designing a novel polymer structure is called for.

### SUMMARY OF THE INVENTION

The invention provides a blend, comprising 20 to 80 parts by weight of polycarbonate, 20 to 80 parts by weight of polyarylate, and 20 parts by weight of copolymer having a formula as

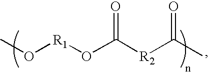

wherein R₁ is a combination of at least two groups of ethylene, cyclohexlene dimethylene, 2-methyl propyl, and neopentyl, R₂ is a combination of at least two groups of naphthalene, phenylne, butyl, and hexyl, and n is a number of 1500 to 3000.

The invention also provides a packaging material comprising the described blend.

A detailed description is given in the following embodiments.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a blend, comprising 20 to 80 parts by weight of polycarbonate, 20 to 80 parts by weight of polyarylate, and 20 parts by weight of copolymer having a formula as formula 1.

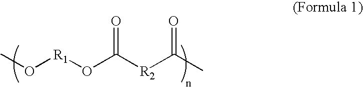

In Formula 1, R₁ is a combination of at least two groups of ethylene, cyclohexlene dimethylene, 2-methyl propyl, and neopentyl, R₂ is a combination of at least two groups of naphthalene, phenylne, butyl, and hexyl, and n is a number of 1500 to 3000. In one embodiment, R1 is a combination of cyclohexylene dimethylene and ethylene with a molar ratio of 1:99 to 99:1, and preferably of about 25:75 to 35:65.

The blend is formed by physical compounding. In one embodiment, different ratio of PAR, PC, and copolymer having the Formula 1 are blended to form the blend. For example, the injection molding for the blend includes a screw with a diameter of 45 mm, a feed inlet having a temperature of 230° C. to 250° C., an injecting section having a temperature of 230° C. to 250° C., and an injecting pressure of 100 kg/cm² to 200 kg/cm² to complete a product. The product is dried at 120° C. for 3 hours. If the described injection molding is applied to package LEDs, the cycle time is only 30 to 60 seconds, thereby saving time costs. Because the blend from the injection molding has a transparency greater than 85%, a thermal resistance greater than 100° C., and high yellowing resistance under UV/climate greater than 1500 hours, the blend is suitable to be applied in packaging material for light emitting device (e.g. OLED).

### EXAMPLES

### Example 1

3 mole of 1,4-cyclohexylene dimethanol (hereinafter CHDM), 7 mole of ethylene glycol, and 10 mole of benzene dicarboxylic acid were charged in a round bottle, heated to 240° C. to 290° C. and then vacuumed for processing a condensation polymerization to yield a copolymer PETG. Different weight ratio of PETG, polycarbonate (PC-175D, commercial available from Chimei-Asahi Chemical Company, Taiwan), polyarylate (U-polymer®, commercial available from Unitika, Japan), and PEN (commercial available from ShinKong Synthetic Fibers Corporation, Taiwan) were blended, and the blend properties such as viscosity, transparency, and yellowing resistance were measured. The component weight ratio and properties of these blends were tabulated as in Table 1.

TABLE 1

| PC | PET | PA | PEN | | | | Yellowing |
|---|---|---|---|---|---|---|---|
| weight | G weight | R weight | weight | | Tg | Transparency | resistance |
| ratio | ratio | ratio | ratio | Viscosity | (° C.) | (%) | (hour) |
| 100 | 0 | 0 | 0 | Not analyzed | 130 | 90 | <1000 |
| 0 | 100 | 0 | 0 | 0.57 | 67.8 | 88 | >3000 |
| 0 | 0 | 100 | 0 | 0.63 | 190.2 | 85 | >1500 |
| 80 | 20 | 0 | 0 | 0.60 | 112 | 88 | >1000 |
| 50 | 50 | 0 | 0 | 0.63 | 103.4 | 88 | >1500 |
| 20 | 80 | 0 | 0 | 0.63 | 105 | 84 | >1000 |
| 80 | 0 | 20 | 0 | 0.60 | 151.3 | 87 | >1000 |
| 50 | 0 | 50 | 0 | 0.63 | 163.7 | 85 | >1500 |
| 20 | 0 | 80 | 0 | 0.53 | 172.3 | 85 | >1500 |
| 60 | 20 | 20 | 0 | 0.61 | 118.3 | 85 | >1500 |
| 40 | 30 | 30 | 0 | 0.58 | 126.8 | 86 | >2000 |
| 0 | 0 | 0 | 100 | 0.65 | 120 | 88 | >1000 |
| 80 | 0 | 0 | 20 | 0.67 | 128.3 | 90 | >1000 |
| 50 | 0 | 0 | 50 | 0.62 | 124.7 | 88 | >1000 |
| 20 | 0 | 0 | 80 | 0.65 | 121.3 | 88 | >1000 |
| 0 | 0 | 80 | 20 | 0.58 | 169.1 | 86 | >1000 |
| 0 | 0 | 50 | 50 | 0.58 | 154.5 | 86 | >1000 |
| 0 | 0 | 20 | 80 | 0.60 | 127.6 | 88 | >1000 |

Accordingly, the blends have transparency greater than 85% and yellowing resistance under UV and/or climate greater than 1500 hours.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A blend, comprising:
20 to 80 parts by weight of polycarbonate;
20 to 80 parts by weight of polyarylate; and
20 parts by weight of copolymer having a formula as: 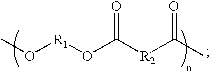
wherein R₁ is a combination of at least two groups of ethylene, cyclohexlene dimethylene, 2-methyl propyl, and neopentyl;
R₂ is a combination of at least two groups of naphthalene, phenylne, butyl, and hexyl; and
n is a number of 1500 to 3000.

2. The blend as claimed in claim 1, wherein R1 is a combination of cyclohexylene dimethylene and ethylene having a molar ratio of 1:99 to 99:1.

3. The blend as claimed in claim 1 having a transparency greater than 85%.

4. The blend as claimed in claim 1 having a thermal resistance greater than 100° C.

5. The blend as claimed in claim 1 having a yellowing resistance under UV and/or climate greater than 1500 hours.

6. A packaging material, comprising the blend as claimed in claim 1.
